(19) United States
(12) Patent Application Publication
(10) Pub. No.: US 2004/0039788 A1
(43) Pub. Date: Feb. 26, 2004

(54) Relaying system for broadcasting multi-channel internet television and networking method thereof

(76) Inventors: Byeong-Jin Lim, Seoul (KR); In-Keon Lim, Seoul (KR); Dae-Joong Kim, Suwon (KR)

Correspondence Address: JAGTIANI + GUTTAG, 10363-A DEMOCRACY LANE, FAIRFAX, VA, 22030, US

(21) Appl. No.: 10/224,277

(22) Filed: Aug. 21, 2002

(51) Int. Cl. G06F 15/167

(52) U.S. Cl. 709/214; 709/231; 725/114

(57) ABSTRACT

The present invention discloses a relaying system for multi-channel Internet broadcasting from a local live server.

The present invention makes it possible to have a multiple of live relaying servers shared by several local servers depending on the number of connections requested by client computers.

### FIELD OF THE INVENTION

The present invention relates to a relaying system for broadcasting multi-channel internet television and networking method thereof, and more particularly to a multi-media relaying technology which alleviates the burden of the maintenance of the live servers and minimizes the network bandwidth for the data transmission from the servers.

1. Description of the Related Art

Recently, a great deal of attention has been made on the Internet broadcasting with the increase of the number of Internet users. As a typical type of server for broadcasting moving pictures on Internet, either Windows Media Server from Microsoft Corporation or Real Server from Real Network Corporation has been widely used.

FIG. 1 is a schematic diagram illustrating an Internet broadcasting system based upon client-server architecture in accordance with a prior art. Referring to FIG. 1, architecture of a client 20 with a live server 20 is employed for the transmission of the data stream.

The camera-captured images are encoded and then transmitted with the audio data to the client 90 for the live webcasting. In case of VOD (video on demand), the encoded data is fetched by the server from the storage means and then sent to the client.

Now, when a multiple of clients 90 are trying to have an access to a live server 20, we can not avoid a lot of working load both to the server 20 and to the network.

In order to resolve the overload problem in the client-server architecture, a clustering technique has been proposed.

FIG. 2 is a schematic diagram illustrating a clustering technique in accordance with the prior art.

Referring to FIG. 2, the clustering method according to prior art relies on a technique of load balancing, namely of distributing the connections of a multiple of clients 90 with a multiple of servers 110, 111, 112, and 113.

The clustering method illustrated in FIG. 2, however, is not suitable for the live webcasting, which broadcasts the encoded data for moving pictures in real time. This is because it is difficult to synchronize the stored data for the real-time moving pictures in a multiple of servers 110, 111, 112, 113.

Therefore, it is necessary to have a high-performance server for a real-time live broadcasting on Internet to a great number of clients. It is also necessary to have a network line with a large bandwidth to maintain a quality of the real-time broadcasting.

However, it is not practically easy for a content-provides to have a high-performance server as well as a network line with a large bandwidth.

Moreover, in the case of the multi-channel broadcasting system, which broadcasts the real-time traffic conditions of the roads, it is not economical to prepare a great number of high performance live servers on the roads and network with a large bandwidth.

Since each server is responsible for one channel according to the prior art, each broadcaster suffers from the financial burden for the maintenance of the live server and the network that increases in a proportional manner to the number of channels.

Furthermore, since there should be a technical limit for a single server to accommodate for the number of clients, it happens that the live server can not respond to the request of the client if the number of requesting clients at a certain line increases rapidly.

Practically it is not even economical to increase the number of servers in accordance with the traditional clustering technique because we have to increase the capacity of the local network simultaneously.

Therefore, it is recommendable both technically and economically to increase the number of high-performance broadcasting servers simply because of an instantaneous increase of the number of clients trying to be connected to the broadcasting servers.

### SUMMARY OF THE INVENTION

In view of there problems, there is a need in the art for a relaying system, especially for broadcasting multi-channel internet television and networking method thereof, which are not subject to these limitations.

Accordingly, it is an object of the present invention to provide a relaying system and method for Internet television broadcasting.

It is further an object of the present invention to provide a relaying system and method of minimizing the number of live servers and the maintenance for Internet television broadcasting.

Yet it is an object of the present invention to provide a relaying system and method of minimizing the bandwidth of the network for Internet television broadcasting.

It is another object of the present invention to provide a relaying system and method, which can be expanded without giving rise to the existing local network even in a case of instantaneous increase of clients requesting the live broadcasting data stream.

Yet it is an object of the present invention to provide a relaying system and method that resolves the degradation of the image quality due to the reduction of frame per second of the prior art.

Yet it is an object of the present invention to provide a relaying system and method that allows a local internet broadcasting object to relay the live internet television program to a multiple of clients with high-quality images of moving pictures.

### BRIEF DESCRIPTION OF THE DRAWINGS

Further features of the present invention will become apparent from a description of the internet television broadcasting and relaying technology taken in conjunction with the accompanying drawings of the preferred embodiment of the invention, which, however, should not be taken to be limitative to the invention, but are for explanation and understanding only.

In the drawings:

FIG. 1 is a schematic diagram illustrating an Internet broadcasting system that is based upon the conventional client-server architecture according to the prior art.

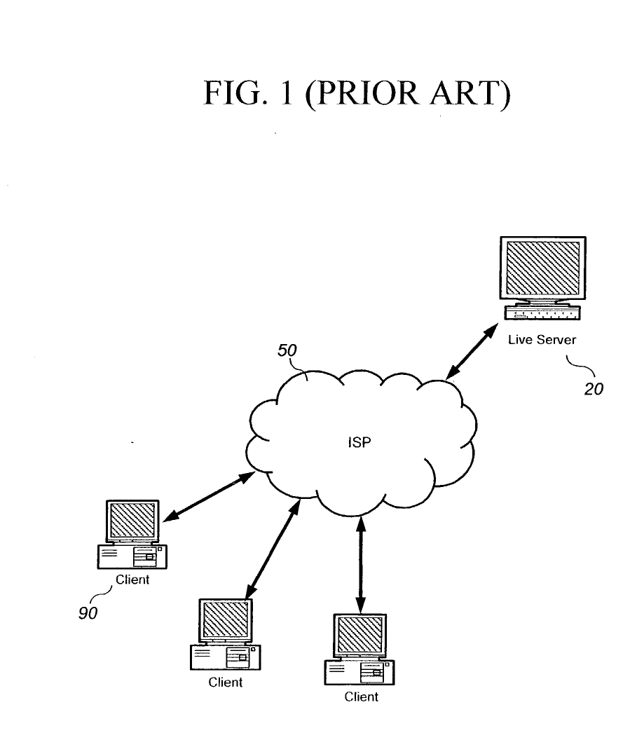

FIG. 2 is a schematic diagram illustrating an Internet broadcasting system that is based upon the clustering architecture according to the prior art.

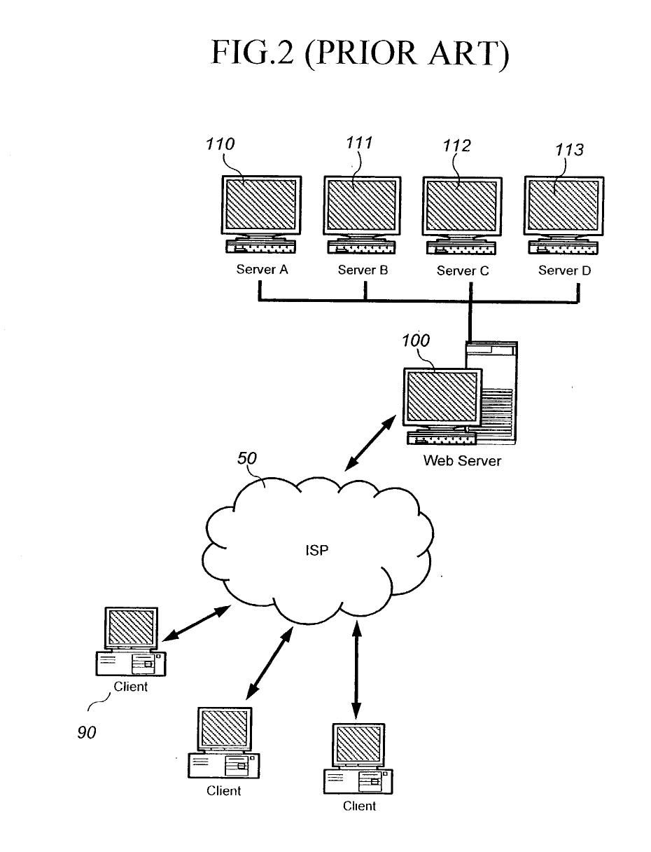

FIG. 3 is a schematic diagram illustrating a preferred embodiment of a relaying system for an Internet television broadcasting in accordance with the present invention.

FIG. 4 is a schematic diagram illustrating a first embodiment of a relaying method for an Internet television broadcasting in accordance with the present invention.

FIG. 5 is a schematic diagram illustrating a second embodiment of a relaying method for an Internet television broadcasting in accordance with the present invention.

FIG. 6 is a schematic diagram illustrating a third embodiment of a relaying method for an Internet television broadcasting in accordance with the present invention.

### DETAILED DESCRIPTION OF THE PREFERRED EMBODIMENT OF THE INVENTION

The present invention will be explained in detail with reference to the accompanying drawings.

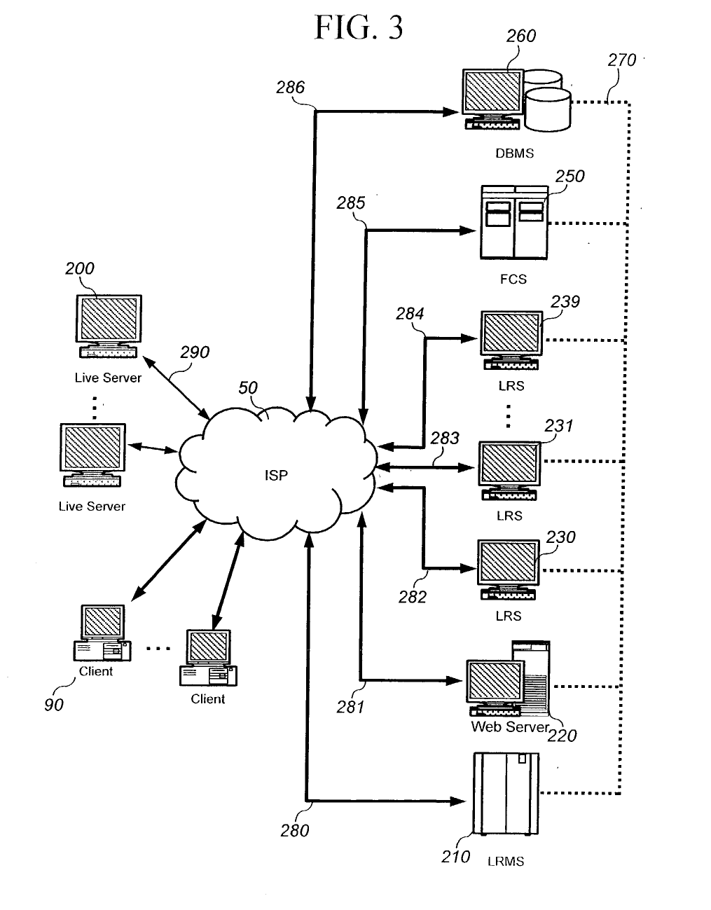

FIG. 3 is a schematic diagram illustrating a preferred embodiment of a relaying system for Internet television broadcasting in accordance with the present invention.

Referring to FIG. 3, a multiple of individual live servers 200 provide a real-time live broadcasting service, respectively. Namely, the live server 200 sends a stream of encoded audio and video data for television broadcasting on Internet.

Since each live server for each channel can not afford to broadcast Internet television program to time-varying number of clients, each local live server sends its data stream to the relaying system in accordance with the present invention. The relaying system is then responsible for broadcasting of multi-channels through the system comprising the live relay management server (LRMS) 210, web server 220, a multiple of relaying servers 230, 231, 239, a frame conversion server (FCS) 250, and a database management server (DBMS) 260.

Each live server 200 can be regarded as an individual local broadcaster transmitting its own multimedia contents on its own channel. The mission for providing the multimedia contents, i.e. Internet television program, to each client 90 is performed by the relaying system in accordance with the present invention.

Consequently, each live server does not care about the issue of broadcasting the internet television program to a huge number of clients because the load balancing for the efficient use of the relaying servers or the network is monitored by the relaying server system of a third party.

As a preferred embodiment in accordance with the present invention, each live server can be regarded as a local live broadcasting camera installed on the road for monitoring the traffic condition of the specific road.

In this case, it is necessary to be able to assign the relaying workload to live relaying servers in an adaptive manner to the amount of request for a certain channel in order to maintain an acceptable quality of television images as well as the optimum load balancing.

According to the present invention, each live server 200 transmits a stream of data through relaying servers 230, 231, 239 of which the number is determined by the number of clients requesting the instantaneous connection

In the meanwhile, each live server has to be well-prepared for a high-performance server system with a high-speed network in order to cope with a situation when the number of the instantaneous request for the internet television broadcasting from the clients is sky rising in accordance with the prior art.

The present invention makes it possible for each live server 200 to prepare for the minimum-performance server, which is capable of transmitting a stream of video and audio data only to a single relaying server for one channel, and a network with a minimum bandwidth.

The relay system for Internet broadcasting in accordance with the present invention has a feature in a sense that a data stream including the audio and video data is copied in a memory as much as all the clients can be afforded with a specific channel they are requesting.

The servers that can relay the data stream from the live server 200 are live relay servers (LRS) 230, 231, 239, depicted in FIG. 3.

The number of the live relay servers 230, 231, 239 in accordance with the present invention can be determined under the consideration both of the number of expected clients 90 and of the number of requesting clients 90 for a specific channel.

Referring to FIG. 3 again, the relaying system for Internet broadcasting in accordance with the present invention comprises a live relaying management server (LRMS) 210. The LRMS 210 fetches the data stream from a live server 200 broadcasting a specific channel and distributes the load for broadcasting the copies of the data stream to a multiple of clients 90.

The web server 220 is responsible for downloading the computer program to each client computer 90 for receiving the relayed Internet television broadcasting.

As a matter of fact, the Internet user watching the multi-channel Internet television tends to simply browse the broadcasting channels. In other words, the Internet user browses the menu of channel selection and enjoys surfing the channels.

Consequently, the relaying system has to respond to the user's unintentional selection of a certain channel during the surfing of channels and has to send a data stream for moving picture corresponding to a channel the user browses.

This is because the channel browsing causes an unnecessary relaying load from a huge number of clients.

Therefore, the relaying system for internet broadcasting in accordance with the present invention comprises a frame conversion server (FCS) 250 which stores a set of still images such as JPG files for each channel and sends the still images while the client just browses the channel.

As a preferred embodiment, the frame conversion server 250 stops to send a still image to the client 90 if the client 90 keeps on requesting a certain channel.

Referring to FIG. 3, the live relaying servers 230, 231, 239, the LRMS 210, and the web server 220 are connected to ISP 50 through the individual network of their own use.

As a preferred embodiment in accordance with the present invention, the LRMS 210 and the web server 220 can be connected to the individual T1 network 280, 281 of their own exclusive use. More preferably, the live relaying servers 230, 231, 239 being connected to the individual T3 network 282, 283, 284 of their own exclusive use.

The network architecture in accordance with the present invention is that the individual servers 210, 220, 230, 231, 239, 250, 260 have their own network for their exclusive use and thereby returns the requested channel through their own network to the clients 90.

Consequently, the network architecture in accordance with the present invention makes it possible to prevent the data of the external network 280, 281, 282, 283, 284, 285, 286 from flowing into the internal network 270 of the relaying system for internet broadcasting.

Therefore, it is not necessary to increase the capacity of the internal network due to the increased network traffic even when the extra number of live relaying servers are installed to accommodate the request for relaying the channel.

The internal network 270 of the relaying system for internet television broadcasting can be implemented with equipment for megabyte per second transmission, and can be expanded simply by adding an extra live relay server when the system capacity needs to be upgraded.

The data stream passing through the internal network 270 includes only the traffic due to the MPEG frame from LRS 220 to FCS 250, the JPG image signal from the database server 270 to the web server 220, and the control signal of LRMS 210.

Consequently, the present invention has a feature that the internal network 270 does not suffer from a heavy traffic of data stream even when a huge number of clients are simultaneously requesting for a certain broadcasting channel.

In other words, the present invents makes it possible to accommodate for the instantaneous rise of clients requesting for internet broadcasting simply by increasing the number of LRS 230 without disturbing any network or the architecture having a traditional megabyte-transmission capacity.

Initially, the client program installed in the host computer 90 tries to be connected to the LRMS 210 when a request for a certain broadcasting channel is made to the web server 220. The LRMAS 210 in accordance with the present invention makes an order that the client 90 should be connected to an LRS 230 if the LRS 230 is available and is now broadcasting the channel that the client 90 wants receive.

If none of LRS 230, 231, 239 is currently broadcasting the requested channel from the client 90, the LRMS 210 makes an order to an LRS currently with a minimum working load that it should be connected with the live server 200 which broadcasts the requested channel.

Furthermore, the LRMS 210 makes an order that the client program 90 should be connected to the active LRS 230 that is receiving data stream from the live server 200 broadcasting the requested channel.

In this case, it may happen that the relaying server, which is now broadcasting the requested channel, can not afford to further relay the channel to any more client computer for the optimum relaying performance of an LRS 230.

In this case, the LRMS 210 makes an order to a second LRS 231, which is capable of taking over the relaying workload, that a second LRS 231 should receive a copied data stream of the internet television program from a first LRS 230.

Further, the client programs 90 requesting the television channel are suggested to connect to a second LRS 231 from now on. As a consequence, the present invention makes it possible to broadcast a multiple of internet television channels from a multiple of live servers 200 very efficiently with a high-quality images even if the number of clients 90 requesting a specific channel rises very rapidly at the same instant.

Therefore, the relaying system in accordance with the present invention makes it possible for the service providers to minimize the hardware specification of the live server system and accompanying network.

For instance, suppose the network to the live server 200 is a 256 KBPS line, then a data stream of one channel use all the bandwidth of the network in accordance with the prior art. Further, if two client computers are connected, then each channel is assigned only with 128 KBPS bandwidth.

Consequently, the quality of image and the frame per second processed in the prior art will be deteriorated. In the meanwhile, the present invention guarantees only one connection between the live server 200 and the live relay server 230 irrespective of the number of clients.

As a preferred embodiment in accordance with the present invention, a business model can be proposed such that the occupancy of the network and the amount of service of live relay servers 230 for broadcasting a certain channel can be charged to a local live server 200.

The relaying system in accordance with the present invention performs a function of so-called switch connecting the local live server 200 and the client 90. The number of live relaying server 230 in accordance with the present invention varies in a proportional manner with the number of client requesting a certain channel of Internet broadcasting.

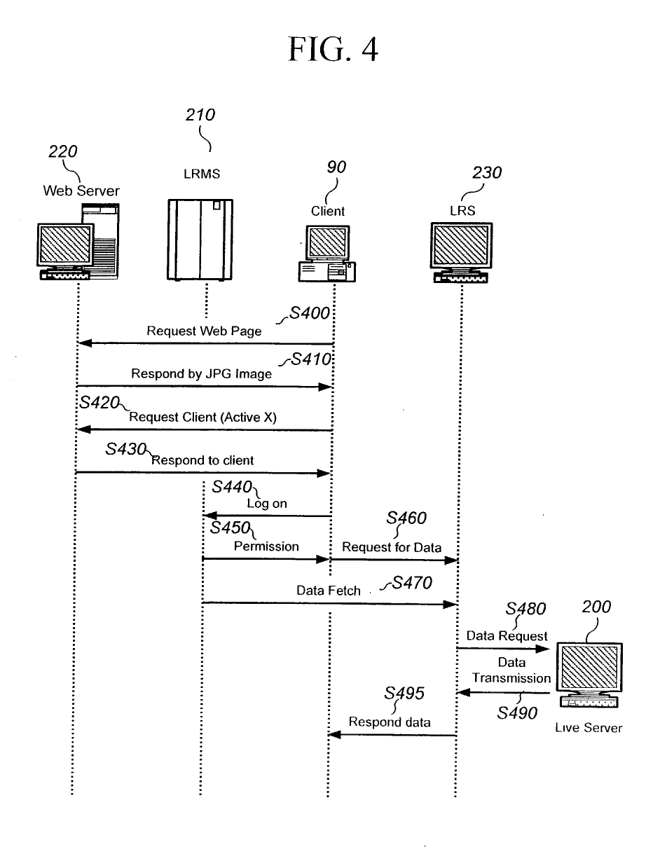

FIG. 4 is a schematic diagram illustrating a first embodiment of the relaying method in accordance with the present invention. Referring to FIG. 4, a request for a web page of Internet broadcasting is made to a web server 220 of the relaying company for Internet television broadcasting (step S400).

The web server 220 in accordance with the present invention responds to the client 90 by sending a web page (step S410). As a preferred embodiment in accordance with the present invention, the web server 220 can respond to the request by sending a JPG image at an initial stage of channel surfing.

Thereafter, a request for a client program (Active X) can be made through clicking the JPG image of the web page (step S420). The web server 220 now tries to connect the LRMS 210 (step S440) after responding to the client 90 (step S430).

In this case, the identification (ID), password, and the address information of the live server 200 can be informed to the LRMS 210. The LRMS 210 gives permission to the client 90 (step S450), and asks the live relay server 230 to send the data stream of the requested channel of broadcasting (step S460).

If the LRS is not available which currently relays the broadcasting of the requested channel, an order is given to an LRS to fetch the data stream from the live server 200 (step S470).

Furthermore, the live relay server 230 relays the data stream to the client 90 (step S495) after the data stream has been transmitted from the live server 200 (step S490).

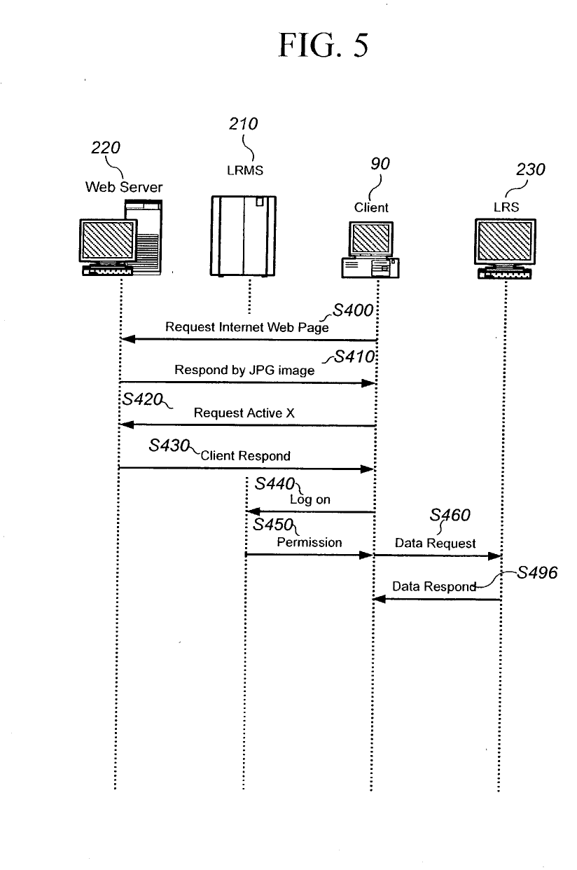

FIG.5 is a schematic diagram illustrating a second embodiment of the relaying method in accordance with the present invention. The second embodiment in accordance with the present invention discloses a relaying method applicable when an LRS is available is broadcasting the requested channel and when the connecting capacity allows the currently requesting client to be connected.

Referring to FIG. 5, the steps from S400 through to S450 are the same as the ones described in the aforementioned first embodiment in accordance with the present invention.

It may happen that an LRS is available that is broadcasting the requested channel. Furthermore, the number of the currently connected clients has not exceeded the allowed connecting capacity. In this case, the LRMS 210 makes an order to the client such that the client 90 should be connected to the available LRS 230 (step S460).

Now, the LRS 230 makes as many copies as the number of the clients 90 in the memory and send then to each client 90 (step S496).

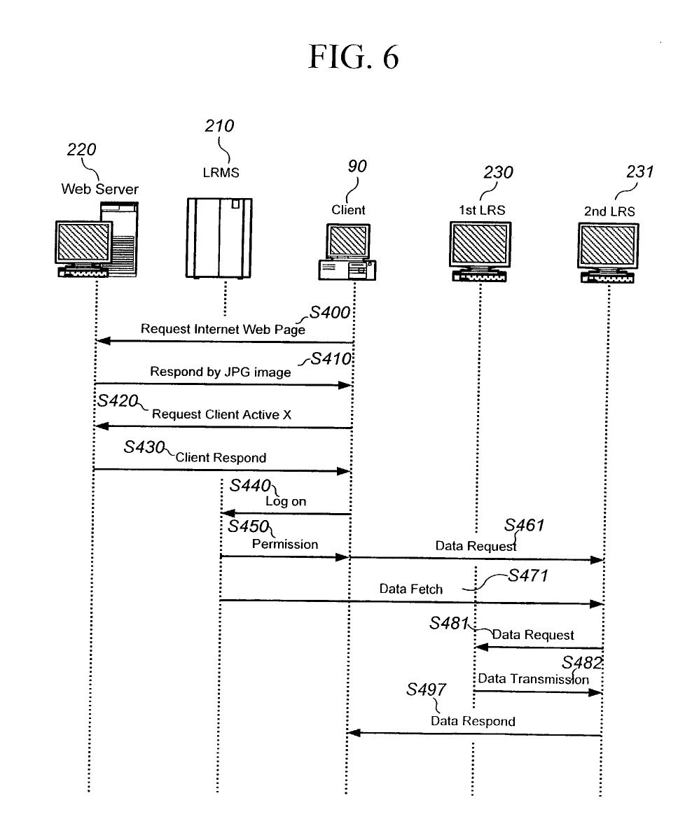

FIG. 6 is a schematic diagram illustrating a third embodiment of the relaying method in accordance with the present invention. The third embodiment of the present invention discloses a relaying method applicable in a case when the number of requests from the clients 90 exceeds the connecting capacity of a first LRS 230.

In this situation, a second LRS 231 receives a data stream of the requested channel from a first LRS 230 through the local network 270 and then relays the data stream to the client 90.

Referring to FIG. 6, the steps from S400 through to S450 can be referred to the description made in a first embodiment. The LRMS 210 makes an order such that the client 90 should be connected to a second LRS 231 currently with a minimum workload (step S461).

The LRMS 210 now makes order that a second LRS 231 should receive the data stream from the first LRS 230 (step S471). The second LRS 231 requests a data stream to the first LRS 230 through the local network (step S481). Then the second LRS 231 responds to the client 90 by sending the data stream (step S497).

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A relaying system for internet broadcasting, comprising:
a live server broadcasting a channel by sending a encoded data system;
a live relaying server relaying the data stream of the requested channel to the client either from the live server or from another relaying server;
a live relaying management server performing a process of taking a data stream of the requested channel from said live server and a process of distribute the connection of the requesting clients to the multiple of live relaying servers; and
a web server providing an interface for watching the Internet television and a client program for having access to said live relaying management server.

2. The relaying system for internet broadcasting as set forth in claim 1 wherein said live relaying server, said live relaying management server, and said web server have independent communication networks of their own use that are connected to internet.

3. The relaying system for internet broadcasting as set forth in claim 1 wherein said live server has a single connection with said live relaying server, irrespective of the number of clients requesting the channel from said live server.

4. The relaying system for internet broadcasting as set forth in claim 1, further comprising:
a frame conversion server converting the I-frame from said live server into an image file that is to be provided to a client during channel surfing step; and
a database server storing said image file.

5. The relaying system for internet broadcasting as set forth in claim 1 wherein said live relaying management server makes:
an order that the requesting client should be connected to a first live relaying server relaying the requested channel if said first live relaying server currently relaying the requested channel is available and if the connection capacity of said first live relaying server has not been exceeded by the number of the connected clients;
an order that the requesting client should be connected to a second live relaying server that is supposed to receive a data stream of the requested channel from said first live relaying server that is not allowed to be connected to more than a predefined number of the requesting clients due to the limit of the connection capacity; and
an order that a third live relaying server should receive a data stream of the requested channel from the live server if said third live relying server currently has minimum working load and be connected to the requesting client.

6. A relaying method for internet broadcasting, comprising steps of:
(a) providing a web page to a client that has been connected to a web server of Internet broadcasting;
(b) receiving a request for a channel from said client that has been connected to a live relaying management server through the client program of said web page;
(c) checking if a live relaying server is available that is relaying the requested channel and if the number of the connections to said live relaying server exceeds a predefined capacity of the connections;
(d) connecting client to a first live relaying server if said first live relaying server is available according to the step of (c);
(e) connecting said client to a second live relaying server that receives the data stream of the requested channel from said first live relaying server if the number of the connections to said first live relaying server exceeds a predefined capacity of the connections according to the step of (c); and
(f) connecting said client to a third live relaying server that receives the data stream of the requested channel from said live server if none of the live relaying servers is currently relaying said requested channel wherein said third live relaying server has the minimum working load.

7. A relaying method for internet broadcasting of multi-channels to a multiple of clients, comprising steps of:
sending a data stream of a channel of a live server to a live relaying management server through a first network;
relaying said data stream of said channel through said relaying server to a client requesting said channel under the control of said live relaying management server, and/or transmitting said data stream of said channel to a second relaying server under the direction of said live relaying management server via the local network; and
said client's receiving a relayed data stream of said channel either from said first live relaying server or from said live relaying server.

8. The relaying method as set forth in claim 7, further comprises steps of:
converting a frame of a channel of a live server to an image file through a frame conversion server and storing said image file in a database server; and
sending said stored image file to a client through said live relaying management server during the channel-surfing step of said client.

9. The relaying method as set forth in claim 6 or claim 7 further comprises a step of:
said live relaying management server's monitoring the history of connections between the live relaying servers and the clients for relaying the channel and advising said live server of said history of use.

10. A relaying method for internet broadcasting of multi-channels to a multiple of client, comprising steps of:
logging on a live relaying server by a frame conversion server;
said frame conversion server's requesting an I-frame to said live relaying server;
said live relaying server's sending said I-frame to said frame conversion server;
said frame conversion server's converting said I-frame into an image file and storing in the database server;
a client's requesting a web page to a web server of said live relaying server;
said web server's responding to said client by sending a web page including said image file corresponding to a channel that is pointed during the channel surfing;
a client's requesting a client program for watching the channel corresponding to said image file by clicking on said image file; and
connecting said web server to said client with a live relaying server relaying said requested channel.

11. The relaying method as set forth in claim 10 further comprises steps of:
said web server's responding to said client by advising said client by advising said to be connected to a live relaying management server; and
said client's receiving a data stream of the requested channel by connecting to a live relaying server that is under the control of said live relaying management server.

12. The relaying method as set forth in claim 10 further comprises a step of:
said frame conversion server's requesting an I-frame to said live relaying server in a periodical manner, converting said I-frame into an image file, and storing said image file in a database.

13. A relaying method for internet broadcasting of multi-channels to multiple of clients, comprising steps of:
A frame conversion server's converting an I-frame from a Internet broadcasting web server into an image file and to store in a database;
a client's requesting for a web page to said Internet broadcasting web server;
said internet broadcasting web server's responding to said client by sending a web page including said image file fetched from said database;
said client's requesting for a client program by clicking on said image file in order to watch a channel corresponding to said image file; and
said Internet broadcasting web server's sending a data stream of the requested channel to said client.
